(19) United States
(12) Patent Application Publication
(10) Pub. No.: US 2007/0256797 A1
(43) Pub. Date: Nov. 8, 2007

(54) Roll-up door system

(76) Inventors: Steve Orton, Cedar City, UT (US); Bill Weymouth, Kanarraville, UT (US); Shawn Hansen, Cedar City, UT (US); Lewis Young, Cedar City, UT (US)

Correspondence Address: OrCo, Inc.;Attn. Bill Weymouth, P.O. Box 420205, Kanarraville, UT, 84742, US

(21) Appl. No.: 11/429,298

(22) Filed: May 4, 2006

(51) Int. Cl. E05F 15/00

(52) U.S. Cl. 160/188

(57) ABSTRACT

A roll-up door system has been provided to position a roll-up door. The roll-up door system uses a combination of electrical and mechanical systems, to achieve automatic locking and automated maneuvering of the roll-up door. The roll-up door system includes a guide-track assembly, a roll-up door moving along the guide track assembly, a linkage mechanism connected to the roll-up door for guiding the roll-up door along the guide-track assembly, an automated driving mechanism connected to the linkage mechanism for controlling the movement of the roll-up door along the guide-track assembly, and a radio-controlled electrical circuit for activating the automated driving mechanism.

### BACKGROUND

The present invention, in general, relates to roll-up doors. More specifically, it relates to methods and systems for operating and securing roll-up doors.

Roll-up doors are often installed in a garage, on the rear or sides of containers, such as tractor trailer payloads, commercial vans, shipping containers, and cargo containers. A roll-up door includes a flexible sheet, a mechanism to move the flexible sheet up and down, a locking mechanism, and a track to guide the movement of the flexible sheet.

Conventionally, the roll-up doors are operated using a mechanism that requires manual effort to move the flexible sheet up or down. An operator lifts up the flexible sheet to open the roll-up door and pulls down the flexible sheet to close the roll-up door. Sometimes, the operator may attempt to reduce the physical effort required to fully open the roll-up doors by only partially opening the doors. However, the roll-up door may slide down the track. Therefore, to maintain the roll-up door at a particular position in the track, the operator may jam or push objects into the track or at the bottom of the roll-up door. As a result, the track may get damaged. The operator may also be injured.

Moreover, in conventional systems a mechanical lock, such as a padlock, swing-lock and the like is provided, in order to secure and lock roll-up doors. However, the application of the mechanical lock makes the roll-up doors vulnerable to theft or pilferage. Therefore, in order to reduce the vulnerability of the roll-up doors, some roll-up doors have been fitted with systems to open, close and lock the roll-up door. For example, U.S. Pat. No. 6,047,576 assigned to Lanigan, et al., provides a system for roll-up doors which is activated using an exterior key. Upon activation, an interior latch structure is mechanically moved between an unlocked and a locked position. According to U.S. patent publication number 2004/0155477 assigned to Lanigan, et al., a controller has been provided for a motorized interior latch structure. A set of sensors monitor the movement of latch between a locked or an unlocked position. However, the systems described above require the operator to physically maneuver the roll-up door into a position for closing the roll-up door. The operator must either physically operate a key to activate a latch, or signal a controller to operate a motorized latch. Therefore, the operator has to physically operate the roll-up door. Moreover, due to the physical contact, the operator remains prone to the risks of a physical injury.

In order to avoid the physical operation of roll up doors, some roll-up doors are provided with systems that automate the closing and opening of the door. However, such systems do not allow the operator to partially close or open the roll-up door. Moreover, the locking mechanism still remains manual.

In light of the above discussion, there exists a need for a system and a method, which permits an operator to selectively open, close, position and lock a roll-up door. Moreover, the system should involve automatic operation of the roll-up door and the locking mechanism.

### SUMMARY

An objective of the invention is to provide a system for automated operation of a roll-up door.

Another objective of the invention is to provide a system for automated locking of a roll-up door.

Yet another objective of the invention is to provide a system for secure operation of a roll-up door.

Still another objective of the invention is to provide an economical, easy to install, and compact system for operating a roll-up door.

Still another objective of the invention is to provide a system for operating a roll-up door by using a Radio Frequency (RF) transmitter.

The present invention relates to a system for the automated positioning of a roll-up door. The system includes a guide-track assembly, a roll-up door that includes panels moving along the guide track assembly, a linkage mechanism connected to the roll-up door for guiding the roll-up door along the guide-track assembly, an automated driving mechanism connected to the linkage mechanism for controlling the movement of the roll-up door along the guide-track assembly, and a radio-controlled electrical circuit for activating the automated driving mechanism.

Furthermore, the present invention relates to a method for operating a roll-up door system, with the roll-up door system comprising a radio transmitter, a radio-controlled electrical circuit, an automated driving mechanism, a roll-up door and a linkage mechanism. The automated driving mechanism comprises an electric motor, a clutch plate, a driving wheel, a lever-arm mechanism and a solenoid. The method includes receiving a signal at the radio-controlled electrical circuit from an RF transmitter and energizing the solenoid based on the signal by using the radio-controlled electrical circuit. Thereafter, the electric motor is controlled by the radio-controlled electrical circuit on receiving the signal. Further, the lever-arm mechanism is actuated by using the energized solenoid. The lever-arm mechanism in turn engages the clutch plate to the driving wheel and the driving wheel moves the linkage mechanism to move the roll-up door.

The present invention also relates to a method for operating a roll-up door system, with the roll-up door system comprising a radio transmitter, a radio-controlled electrical circuit, an automated driving mechanism, a roll-up door and a linkage mechanism. The automated driving mechanism comprises an electric motor, a clutch plate, a driving wheel, and a solenoid. The method includes receiving a signal at the radio-controlled electrical circuit RF transmitter and de-energizing the solenoid based on the signal. Thereafter, the electric motor is stopped by using the radio-controlled electrical circuit on receiving the signal and actuating the lever-arm mechanism by using the counter-balancing spring. Further, the clutch-disengaging spring disengages the clutch plate from the driving wheel if the roll-up door is at an intermediate position between ends of the guide-track assembly. The engaged clutch plate and driving wheel keep the roll-up door locked if the roll-up door is at one of the ends of the guide-track assembly.

### BRIEF DESCRIPTION OF THE DRAWINGS

The invention will hereinafter be described in conjunction with the appended drawings provided to illustrate and not to limit the invention, wherein like designations denote like elements, and in which:

FIG. 1 illustrates a view of an exemplary operational environment for various embodiments of the present invention;

FIG. 2 illustrates an outside view of a roll-up door system, in an embodiment of the present invention;

FIG. 3 illustrates an outside view of an automated driving mechanism, in an embodiment of the present invention;

FIGS. 4a and 4b illustrate the disengagement and engagement of a clutch plate and a driving wheel in an automated driving mechanism, in accordance with an embodiment of the present invention

FIG. 5 illustrates an outside view of a linkage mechanism, in accordance with an embodiment of the present invention; and

FIG. 6 illustrates a radio-controlled electrical circuit, in accordance with an embodiment of the present invention.

### DETAILED DESCRIPTION OF THE INVENTION

Various embodiments of the present invention provide a method and system for an automated and secure operation of a roll-up door. The roll-up door is operated by using a Radio Frequency (RF) transmitter. The various applications of the method and system include cargo containers for vehicles, security shades, industrial shutters, and roll-up entries into buildings. The embodiments of the present invention also provide a method and system capable of locking the roll-up door, in order to provide security for the various applications.

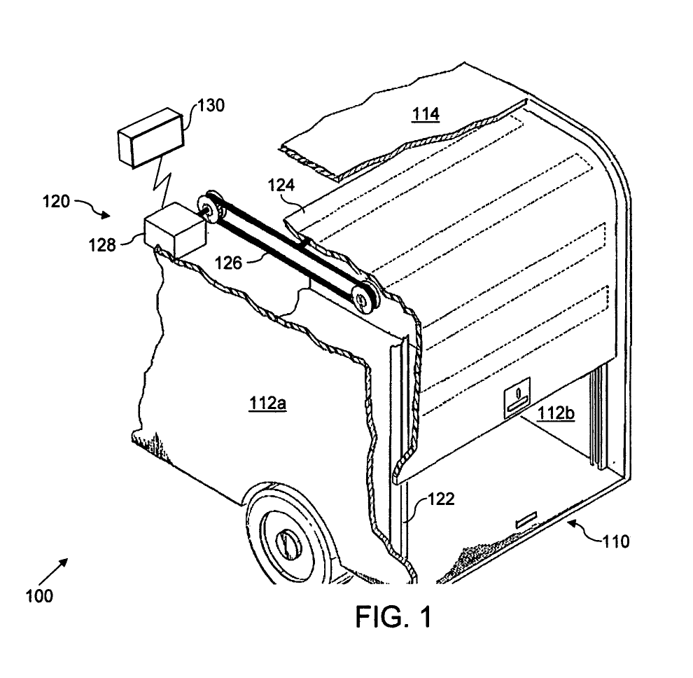

FIG. 1 illustrates a view of an exemplary operational environment 100 for various embodiments of the present invention. Environment 100 includes a container 110 and a roll-up door system 120. Container 110 includes side walls 112a and 112b, and a ceiling wall 114. Roll-up door system 120 includes a guide-track assembly 122, a roll-up door 124, a linkage mechanism 126, an automated driving mechanism 128 and a radio-controlled electrical circuit 130. Guide-track assembly 122 is fixed on side walls 112a and 112b. In various embodiments of the present invention, guide-track assembly 122 is welded, riveted, secured by means of screws to side walls 112a and 112b, and so forth. Roll-up door 124 moves along guide-track assembly 122. Roll-up door 124 moves along guide-track assembly 122 by using a slider-track assembly. The slider-track assembly includes a slider-link, guide-track assembly 122, and roll-up door 124. The slider-link includes a rectangular sliding section and a rod attached at the center of the rectangular sliding section. Moreover, the rod is attached to roll-up door 124. The sliding section is enclosed in guide-track assembly 122. Therefore, roll-up door 124 is secured to move along guide-track assembly 122. In an embodiment of the present invention, roll-up door 124 moves along guide-track assembly 122 by using a roller-track arrangement. The roller-track arrangement includes a roller, guide-track assembly 122, and roll-up door 124. The roller includes a rod, a central core and a pair of wheels. The pair of wheels is connected to each other through the central core. The pair of wheels is free to rotate about the central core. The rod is attached to the central core and roll-up door 124. The roller is enclosed in guide-track assembly 122. Therefore, roll-up door 124 is secured to move along guide-track assembly 122. Further, roll-up door 124 is connected to linkage mechanism 126. In various embodiments of the present invention, linkage mechanism 126 is fixed at one end to ceiling wall 114 through welding, rivets, screws, and other such means. The other end of the linkage mechanism 126 is connected to automated driving mechanism 128. Automated driving mechanism 128 is fixed to side wall 112a. In an embodiment of the present invention, automated driving mechanism 128 is fixed to ceiling wall 114. Automated driving mechanism 128 moves roll-up door 124 on the basis of inputs from radio-controlled electrical circuit 130.

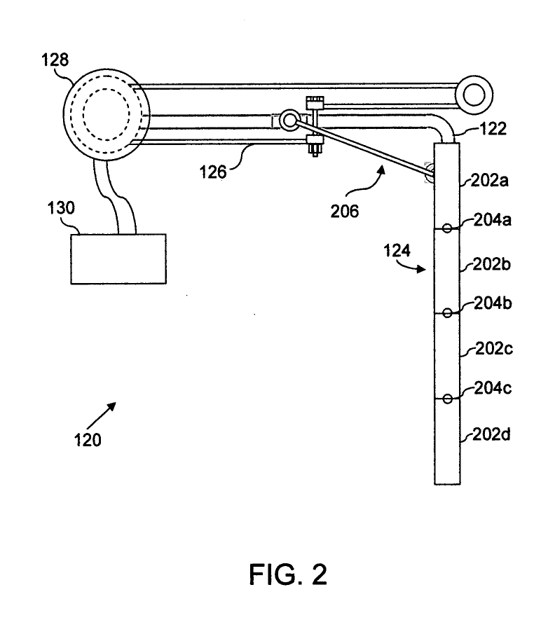

FIG. 2 illustrates an outside view of roll-up door system 120, in an embodiment of the present invention. Roll-up door system 120 includes guide-track assembly 122, roll-up door 124, linkage mechanism 126, automated driving mechanism 128, and radio controlled electrical circuit 130. Roll-up door 124 includes panels 202 and hinges 204. Linkage mechanism 126 includes a slider-arm linkage 206. Hinges 204 connect panels 202 by using screws. Panel 202a is connected to slider-arm linkage 206. Panel 202a moves along guide-track assembly 122 due to the action of slider-arm linkage 206.

Radio-controlled electrical circuit 130 activates automated driving mechanism 128. Thereafter, automated driving mechanism 128 actuates linkage mechanism 126, which moves slider-arm linkage 206. Slider-arm linkage 206 guides panel 202a along guide-track assembly 122. Panel 202a drags along panels 202b, 202c, and 202d, and hinges 204. Therefore, panels 202 move toward ceiling wall 114 or away from ceiling wall 114, based on the actuation of linkage mechanism 126 by automated driving mechanism 128. Roll-up door 124 opens when panels 202 move toward ceiling wall 114. Roll-up door closes when panels 202 move away from ceiling wall 114.

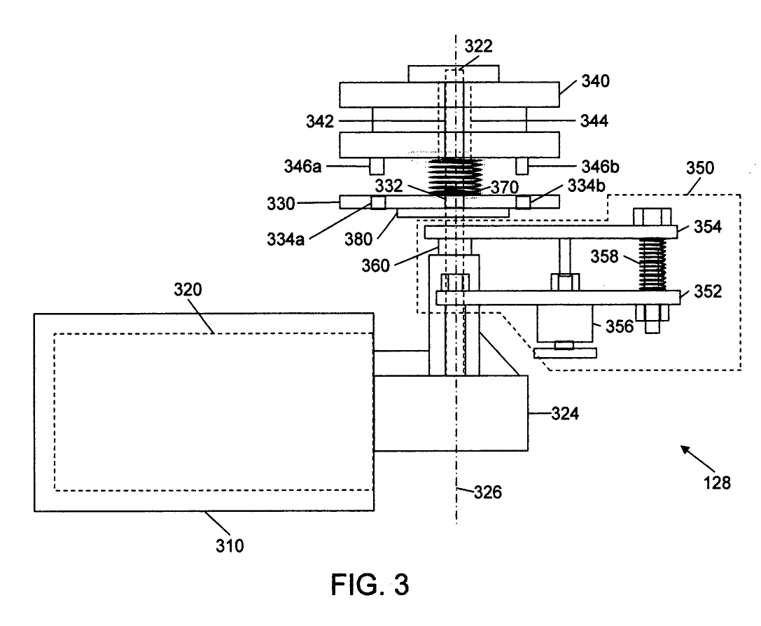

FIG. 3 illustrates an outside view of automated driving mechanism 128, in an embodiment of the present invention. Automated driving mechanism 128 includes a motor housing 310, electric motor 320, a clutch plate 330, a driving wheel 340, a lever-arm mechanism 350, a clutch-disengaging spring 370, and a bearing plate 380. Electric motor 320 includes a drive shaft 322 and a transmission box 324. Clutch plate 330 includes a central groove 332, and holes 334. Holes 334 include a hole 334a and a hole 334b. Driving wheel 340 includes a central hole 342, a bearing 344, and pins 346. Pins 346 include a pin 346a and a pin 346b. Lever-arm mechanism 350 includes a mounting plate 352, a lever arm 354, a solenoid 356, a counter-balancing spring 358, and a spacer ring 360.

In an embodiment of the present invention, automated driving mechanism 128 is fixed to side wall 112a by using a base plate. Motor housing 310 is secured on the base plate and the base plate is fixed to side wall 112a. Electric motor 320 is secured in motor housing 310. Transmission box 324 couples electric motor 320 to drive shaft 322. Further, drive shaft 322 of electric motor 320 fits into central groove 332 of clutch plate 330. Drive shaft 322 is a half shaft and central groove 332 is a semi-circular groove. As a result, free motion of clutch plate 330 on drive shaft 322 is restricted. In various embodiments of the present invention, central groove 332 is a hub and a square groove. Further, drive shaft 322 is a splined shaft, or a square shaft. However, clutch plate 330 is capable of sliding along drive shaft 322. Holes 334 are located at radial locations on clutch plate 330. Pins 346 are located at radial locations on driving wheel 340. Holes 334 are aligned to pins 346 in driving wheel 340 so that holes 334 and pins 346 are capable of engaging if clutch plate 330 slides along drive shaft 322. Bearing 344 is fitted into central hole 342 of driving wheel 340. Driving wheel 340 is a pulley. In an embodiment of the invention, driving wheel 340 is a sprocket wheel. Further, drive shaft 322 is fitted into bearing 344. Therefore, driving wheel 340 is free to rotate about drive shaft 322 due to bearing 344. In an embodiment of the present invention, an end plate is fitted at the end of drive shaft 322, to prevent driving wheel 340 from sliding along drive shaft 322.

Holes 334 are engaged to pins 346 by lever-arm mechanism 350. Mounting plate 352 is secured to motor housing 310. One end of lever arm 354 is pivoted to mounting plate 352 and the other end is in contact with bearing plate 380. Solenoid 356 is fixed on mounting plate 352. Counter-balancing spring 358 is connected to mounting plate 352 at one end, and lever arm 354 at the other end. Solenoid 356 and counter-balancing spring 358 control the position of lever arm 354 along drive shaft 322. Spacer ring 360 is placed concentrically to drive shaft 322. Spacer ring 360 supports the end of lever arm 354 in contact with bearing plate 380.

Lever arm 354 and counter-balancing spring 358 are connected to mounting plate 352 by using a nut-bolt arrangement. In an embodiment of the present invention, the bolt passes through a hole at the pivoted end of lever arm 354. Counter-balancing spring 358 is placed concentrically to the axis of the bolt. Further, the bolt passes through another hole in mounting plate 352. Thereafter, a nut is tightened at the end of the bolt in order to secure lever arm 354 and counter-balancing spring 358, to mounting plate 352.

Clutch-disengaging spring 370 is placed concentrically on drive shaft 322 between clutch plate 330 and driving wheel 340. Bearing plate 380 is placed concentrically on drive shaft 322, and is positioned between lever arm 354 and clutch plate 330.

Radio-controlled electrical circuit 130 activates automated driving mechanism 128 by supplying a current through the power lines of electric motor 320. Further, solenoid 356 is energized by radio-controlled electrical circuit 130. In an embodiment of the present invention, electric motor 320 is a Direct Current (DC) motor. Electric motor 320 is capable of rotating drive shaft 322 bi-directionally along an axis 326. Drive shaft 322 rotates when the voltage is supplied to the power lines of electric motor 320.

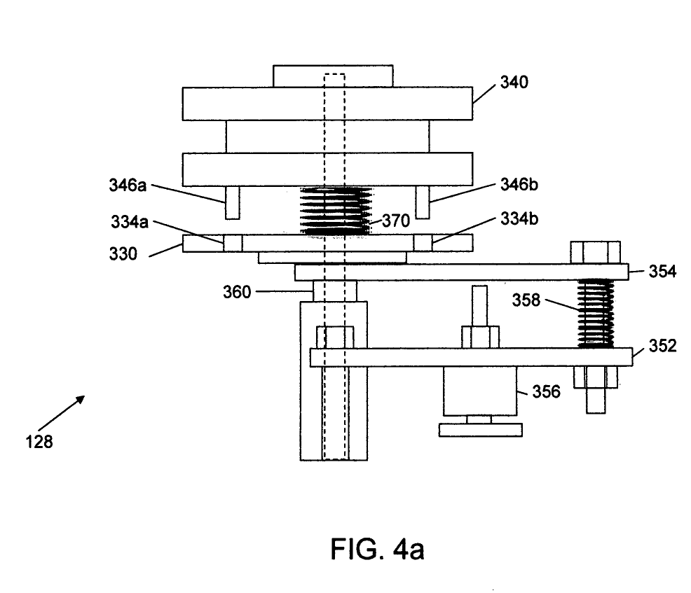

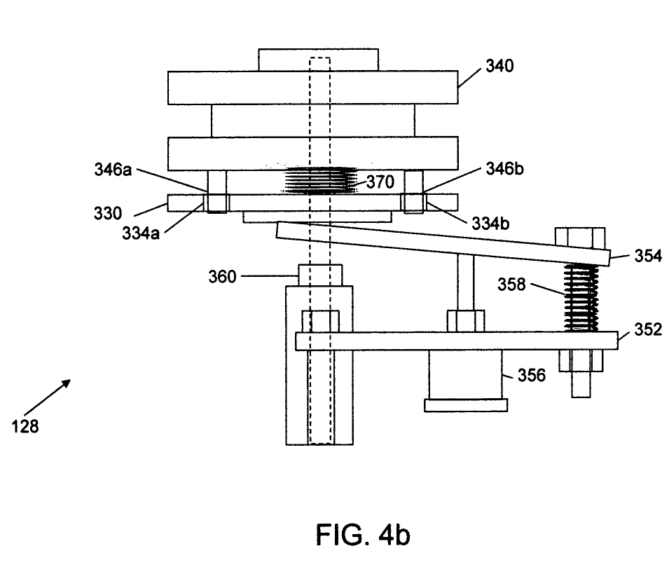

Solenoid 356 includes a ring, a coil wound on the ring and a magnetic core. The core moves relatively to the ring when a current is passed through the coil. Due to the movement of the core, lever arm 354 is pushed along drive shaft 322. Subsequently, lever arm 354 slides clutch plate 330 along drive shaft 322. Holes 334 in clutch plate 330 are engaged with pins 346 due to this sliding movement. The disengagement and engagement of clutch plate 330 with driving wheel 340 is illustrated in conjunction with FIGS. 4a and 4b. Subsequently, drive shaft 322 rotates clutch plate 330. Therefore, driving wheel 340 rotates when voltage is supplied to electric motor 320 and solenoid 356 is energized.

Further, the rotation of driving wheel 340 in one direction moves roll-up door 124 toward ceiling wall 114 and the rotation in another direction moves roll-up door 124 away from ceiling wall 114. The movement toward ceiling wall 114 is referred to as opening roll-up door 124, and movement away from ceiling wall 114 is referred to as closing roll-up door 124.

In an embodiment of the present invention, when electric motor 320 stops and solenoid 356 is de-energized, counter-balancing spring 358 retracts lever arm 354 toward spacer ring 360.

Clutch-disengaging spring 370 disengages holes 334 in clutch plate 330 and pins 346 of driving wheel 340, based on a parameter such as the stiffness of clutch-disengaging spring 370. The stiffness of clutch-disengaging spring 370 is so chosen that a compression force of clutch-disengaging spring 370 is greater than a force, ‘F1’. Force ‘F1’ is the force required to disengage holes 334 in clutch plate 330 from pins 346 of driving wheel 340 when roll-up door 124 is at a location between ends of guide-track assembly 122. Further, the compression force is less than a force, ‘F2’. Force ‘F2’ is the force required to disengage holes 334 in clutch plate 330 and pins 346 of driving wheel 340 when roll-up door 124 is at the ends of guide-track assembly 122. In an embodiment of the present invention, force ‘F2’ is the force required to move driving wheel 340 to release a contact pressure between pins 346 and holes 334 when holes 334 are much larger than pins 346.

In an embodiment of the present invention, electric motor 320 prevents manual operation of roll-up door 124 when holes 334 in clutch plate 330 and pins 346 of driving wheel 340 are engaged. This can be achieved by using a worm gear set in transmission box 324. At the ends of guide-track assembly 122, holes 334 in clutch plate 330 are engaged with pins 346 of driving wheel 340, and transmission-box 324 prevents the movement of roll-up door 124. Therefore, roll-up door 124 is locked at the ends of guide-track assembly 122. Further, at a location between ends of guide-track assembly 122, holes 334 in clutch plate 330 and pins 346 of driving wheel 340 are disengaged. Therefore, driving wheel 340 is free to move and roll-up door 124 can be operated manually.

FIGS. 4a and 4b illustrate the disengagement and engagement of clutch plate 330 and driving wheel 340 in automated driving mechanism 128, in accordance with an embodiment of the present invention. FIG. 4a illustrates an outside view of automated driving mechanism 128 where solenoid 356 is de-energized and no electric current flows across the coil in solenoid 356. The core of solenoid 356 is so positioned that lever arm 354 rests on spacer 360. Holes 334 in clutch plate 330 and pins 346 of driving wheel 340 are disengaged. Therefore, driving wheel 340 is free to rotate on drive shaft 322.

FIG. 4b illustrates an outside view of the automated driving mechanism 128 where the solenoid 356 is in the energized state, that is, current is flowing in the coil of solenoid 356. Lever arm 354 is pushed by the core of solenoid 356. Lever arm 354 in turn, pushes clutch plate 330 along drive shaft 322. Subsequently, holes 334 in clutch plate 330 and pins 346 of driving wheel 340 are engaged, and electric motor 320 rotates driving wheel 340.

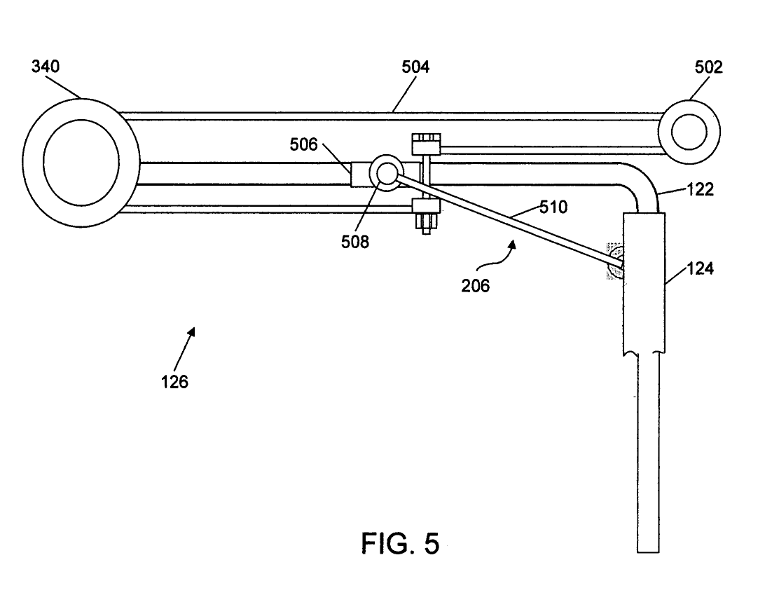

FIG. 5 illustrates an outside view of linkage mechanism 126, in accordance with an embodiment of the present invention. Linkage mechanism 126 includes an idler wheel 502, a power-transmission medium 504, and a slider-arm linkage 206. In various embodiments of the present invention, power-transmission medium 504 is a belt, a chain, or a cable. Further, power-transmission medium 504 includes rings attached to ends in order to connect to slider-arm linkage 206.

Idler wheel 502 is fixed to ceiling wall 114. Power-transmission medium 504 passes over idler wheel 502 and driving wheel 340. One end of slider-arm linkage 206 is connected to power-transmission medium 504 and the end moves along guide-track assembly 122. Another end of slider-arm linkage 206 is connected to roll-up door 124. In an embodiment of the present invention, slider-arm linkage 206 includes a slider 506, a slider-pin 508 and a linkage 510. Slider 506 moves along guide-track assembly 122. Linkage 510 is connected to roll-up door 124. Slider-pin 508 connects slider 506 to linkage 510. In another embodiment of the present invention, slider-arm linkage 206 is a roller-linkage. The roller-linkage includes a roller, a roller pin, and a linkage 510. The roller moves along guide-track assembly 122. Linkage 510 is connected to roll-up door 124. The roller-pin connects the roller to linkage 510. Moreover, power-transmission medium 504 is connected to linkage 510 by using a nut-bolt arrangement. The bolt passes through the rings and a hole in linkage 510. The nut is then fitted onto the bolt.

Driving wheel 340 actuates power-transmission medium 504 of linkage mechanism 126. Power-transmission medium 504 moves idler wheel 502. Slider-arm linkage 206 moves along with power-transmission medium 504 along the guide-track assembly 122. Roll-up door 124 is pulled by slider-arm linkage 206 when driving wheel 340 rotates in a direction such that roll-up door 124 moves toward ceiling wall 114. Roll-up door 124 is pushed by slider-arm linkage 206 when driving wheel 340 rotates in another direction such that roll-up door 124 moves away from ceiling wall 114. Therefore, closing roll-up door 124 involves the pushing of roll-up door 124 by slider-arm linkage 206, and opening roll-up door 124 involves the pulling of roll-up door 124 by slider-arm linkage 206.

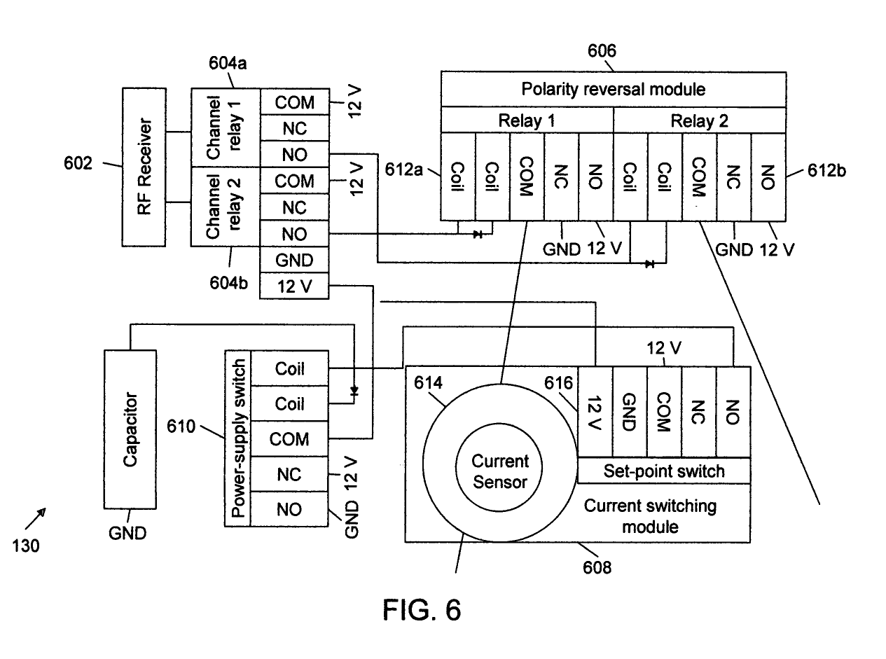

FIG. 6 illustrates radio-controlled electrical circuit 130, in accordance with an embodiment of the present invention. Radio-controlled electrical circuit 130 includes a Radio Frequency (RF) receiver 602, channel relays 604, a polarity reversal module 606, a current-switching module 608, and a power-supply switch 610. Channel relays 604 include channel relay 604a and 604b. Polarity reversal module 606 includes relay 612a and 612b. Current-switching module 608 includes a current sensor 614 and a set-point switch 616. In an embodiment of the present invention, current sensor 614 is an electro-magnet. In various embodiments of the present invention, current sensor 614 is a current sensing microprocessor circuit, a current sensing electrical circuit consisting of transistors, resistors, and diodes and so forth.

Radio-controlled electrical circuit 130 activates automated driving mechanism 128. Channel relays 604 receive input from RF receiver 602. Channel relay 604a includes a common contact point ‘COM’, a normally open contact point ‘NO’, and a normally closed contact point ‘NC’. Channel relay 604b has similar form and functionalities as channel relay 604a. Channel relay 604a has ‘COM’ at 12 Volts (V) DC. In an embodiment of the present invention, channel relays 604 are normally open relays. Channel relays 604 are connected to relays 612 in polarity reversal module 606. Relay 612a includes a coil, a common contact point ‘COM’, a normally open contact point ‘NO’, and a normally closed contact point ‘NC’. Relay 612b has similar form and functionalities as relay 612a. In various embodiments of the present invention, relays 612 in polarity reversal module 606 are electro-mechanical relays, Solid State Relays (SSR), MOSFET H-bridges, and the like. Relays 612 have ‘NC’ at 0 V DC, ‘NO’ at 12 V DC, coils connected to ‘NO’ of channel relays. The ‘COM’ of relay 612a and relay 612b are connected to the power lines of electric motor 320 and solenoid 356. Current sensor 614 in current-switching module 608 measures the current passing through the connection between electric motor 320 and ‘COM’ of relay 612a. Further, current sensor 614 is connected to set-point switch 616. Set-point switch 616 includes a common contact point ‘COM’, a normally open contact point ‘NO’, and a normally closed contact point ‘NC’. The ‘COM’ of set-point switch 616 is connected to 12 V DC. Set-point switch 616 is connected to power-supply switch 610. Power-supply switch 610 includes a coil, a common contact point ‘COM’, a normally open contact point ‘NO’, and a normally closed contact point ‘NC’. Power-supply switch 610 has NC at 12 V DC. The coils of power-supply switch 610 are connected to the ‘NO’ of set-point switch 616. Further, the ‘COM’ of power-supply switch 610 is connected to 12 V DC supplies of channel relays 604 and set-point switch 616. In various embodiments of the present invention, the voltage supplies at the contact points, switches, and relays is 24 V DC, 36 V DC, and so forth.

In an embodiment of the present invention, set-point switch 616 includes an electro-mechanical relay and a printed circuit board. Current sensor 614 is coupled to one of the power lines of electric motor 320. This allows the circuit on the printed circuit board to detect the current passing through the power lines into electric motor 320. The circuit on printed circuit board includes a potentiometer, which enables setting a set-point. When the current passing through the power lines of electric motor 320 exceeds the set-point, the printed circuit board energizes the coil of its electro-mechanical relay.

In an embodiment of the present invention, protection diodes are connected to the coils in various relays and switches. The protection diodes protect transistors and chips from a spike in voltage, when the coil is de-energized. In another embodiment of the present invention, a capacitor is connected to the power-supply switch 610, to increase the time for the coil of power-supply switch to get energized. The capacitor is also connected to set-point switch 616 for increasing the sensitivity of set-point switch 616.

Radio-controlled electrical circuit 130 is controlled by radio signals. In an embodiment of the present invention, the radio signals are transmitted by an RF transmitter. The RF transmitter includes two buttons—an up-button and a down-button. When the up-button and the down-button are pressed, a corresponding RF signal is transmitted to RF receiver 602. The up-button opens roll-up door 124 and the down-button closes roll-up door 124. In an embodiment of the present invention, the up-button is pressed at the RF transmitter when roll-up door 124 is stationary. An up-signal is transmitted by the RF transmitter. RF receiver 602 receives the up-signal and provides an input to channel relays 604. Channel relay 604a changes the state, based on the input. The ‘NO’ of channel relay 604a closes and the voltage at the ‘NO’ of channel relay 604a changes from 0 V DC to 12 V DC. The coil of relay 612b gets energized. The ‘NO’ of relay 612b closes. The voltage at ‘COM’ of relay 612b changes from 0 V DC to 12 V DC. The ‘COM’ of relay 612a is at 0 V DC. Therefore, there is a voltage difference across the power lines of electric motor 320 and solenoid 356. Electric motor 320 moves driving wheel 340 and simultaneously solenoid 356 engages holes 334 in clutch plate 330 and pins 346 of driving wheel 340. In an embodiment of the present invention, in the above-mentioned configuration of power lines of electric motor 320, driving wheel 340 rotates to move roll-up door 124 toward ceiling wall 114.

In an embodiment of the present invention, the up-button is pressed at the RF transmitter when roll-up door 124 is moving toward ceiling wall 114. RF Receiver receives the up-signal and provides the input to channel relays 604. Channel relay 604a changes the state, based on the input. The ‘NO’ of channel relay 604a is already closed and therefore, it opens and the voltage at the ‘NO’ of channel relay 604a changes from 12 V DC to 0 V DC. The coil of relay 612b gets de-energized. The ‘NO’ of relay 612b is already closed and therefore, it opens. The voltage at ‘COM’ of relay 612b changes from 12 V DC to 0 V DC. The ‘COM’ of relay 612a is at 0 V DC. Therefore, there is no voltage difference across the power lines of electric motor 320 and solenoid 356. Electric motor 320 stops driving wheel 340 and simultaneously solenoid 356 is de-energized. Therefore, roll-up door 124 stops moving up.

In an embodiment of the present invention, the down-button is pressed at the RF transmitter when roll-up door 124 is stationary. A down-signal is transmitted by RF transmitter. RF receiver 602 receives the down-signal and provides an input to channel relays 604. Channel relay 604b changes the state based on the input. The ‘NO’ of channel relay 604b closes and the voltage at the ‘NO’ of channel relay 604b changes from 0 V DC to 12 V DC. The coil of relay 612a gets energized. The ‘NO’ of relay 612a closes. The voltage at ‘COM’ of relay 612a changes from 0 V DC to 12 V DC. The ‘COM’ of relay 612b is at 0 V DC. Therefore, there is a voltage difference across the power lines of electric motor 320 and solenoid 356. Electric motor 320 moves driving wheel 340 and simultaneously solenoid 356 engages holes 334 in clutch plate 330 and pins 346 of driving wheel 340. In an embodiment of the present invention, in the above-mentioned configuration of power lines of electric motor 320, driving wheel 340 rotates to move roll-up door 124 away from ceiling wall 114.

In an embodiment of the present invention, the down-button is pressed at the RF transmitter when roll-up door 124 is moving away from ceiling wall 114. RF Receiver 602 receives the down-signal and provides the input to channel relays 604. Channel relay 604b changes the state, based on the input. The ‘NO’ of channel relay 604b is already closed and therefore, it opens and the voltage at the ‘NO’ of channel relay 604b changes from 12 V DC to 0 V DC. The coil of relay 612a gets de-energized. Consequently, the ‘NO’ of relay 612a, which was closed, opens now. The voltage at ‘COM’ of relay 612a changes from 12 V DC to 0 V DC. The ‘COM’ of relay 612b is still at 0 V DC. Therefore, there is no voltage difference across the power lines of electric motor 320 and solenoid 356. Electric motor 320 stops driving wheel 340 and simultaneously solenoid 356 is de-energized. Therefore, roll-up door 124 stops moving away from ceiling wall 114.

In an embodiment of the present invention, the RF transmitter includes three buttons—an up-button, a down-button, and a stop-button. When any of the up-button, the down-button, or the stop-button is pressed, a corresponding RF signal is transmitted to RF receiver 602. The up-button opens roll-up door 124 and the down-button closes roll-up door 124. The stop-button stops roll-up door 124 at a location between ends of guide-track assembly 122.

Current sensor 614 connected to set-point switch 616, measures the current passing through electric motor 320. Set-point switch 616 closes the ‘NO’ when the current in electric motor 320 crosses a predetermined set-point. In an embodiment of the present invention, the predetermined set-point is a fraction of the maximum amperage that electric motor 320 can handle. In various embodiments of the present invention, the predetermined set point is crossed when an obstacle is encountered in guide-track assembly 122, an object prevents roll-up door 124 from moving, roll-up door 124 has reached the end locations of guide-track assembly 122, in case of electrical malfunctions, and so forth. When the predetermined set-point is exceeded, the ‘NO’ of set-point switch 616 is closed. The voltage at the ‘NO’ of set-point switch 616 changes from 0 V DC to 12 V DC. Subsequently, the coil of power-supply switch 610 is energized. The ‘NO’ of power-supply switch 610 closes and the ‘NC’ of power-supply switch 610 opens. The voltage at the ‘COM’ of power-supply switch 610 changes from 12 V DC to 0 V DC. Supplies of channel relays 604 and set-point switch 616 also change to 0 V DC. The voltage difference across electric motor 320 and solenoid 356 is zero and therefore, electric motor 320 stops functioning. Henceforth, roll-up door 124 stops moving. As electric motor 320 stops, current sensor 614 no longer measures any current. Consequently, as the electric current is below the predetermined set-point, the ‘NO’ of set-point switch 616 opens. Subsequently, power is supplied to polarity-reversal module 606 and current-switching module 608, and therefore, radio-controlled electrical circuit 130 is ready to control the movement of roll-up door 124.

Embodiments of the invention have the advantage of maneuvering the roll-up door to any desired position automatically. Further, the roll-up door can also be manually operated. In an embodiment of the present invention, the use of an RF transmitter to automatically control the roll-up door prevents probable injuries to the operator. Embodiments of the present invention provide automatic locking of the roll-up door at the end locations of the guide-track. Further, the embodiments provide a system that is compact, economical, easy to install, and easy to operate.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A roll-up door system comprising:
a guide-track assembly;
a roll-up door comprising a plurality of panels, the panels moving along the guide-track assembly;
a linkage mechanism connected to the roll-up door, wherein the linkage mechanism moving the roll-up door along the guide-track assembly;
an automated driving mechanism connected to the linkage mechanism for controlling the movement of the roll-up door along the guide-track assembly; and
a radio controlled electrical circuit for activating the automated driving mechanism.

2. The roll-up door of claim 1, wherein the guide-track assembly comprises a pair of guide-tracks, each having a lower section, a top section and a curved section.

3. The roll-up door of claim 1, wherein the automated driving mechanism comprises:
an electric motor, the electric motor comprising a drive shaft, wherein the electric motor is secured in a motor housing;
a clutch plate, the clutch plate comprising:
a central groove, the central groove being fitted on the drive shaft; and
one or more holes, the holes being located at one or more radial locations;
a driving wheel, the driving wheel comprising:
a central hole;
a bearing fitted in the central hole, the bearing being fitted on the drive shaft;
one or more pins located radially on the driving wheel, wherein the pins being aligned with the holes in the clutch plate; and
a lever-arm mechanism, the lever-arm mechanism engaging the pins of the driving wheel with the holes in the clutch plate.

4. The roll-up door system of claim 3, wherein the drive shaft is a shaft selected from a group comprising a half shaft, a splined shaft, and a square shaft.

5. The roll-up door system of claim 3, wherein the electric motor further comprises a transmission-box connecting the electric motor to the drive shaft, wherein the transmission box allows transmission of motion from the electric motor to drive shaft.

6. The roll-up door system of claim 3, wherein the driving wheel is selected from a group comprising a pulley, and a sprocket.

7. The roll-up door system of claim 3, wherein the lever-arm mechanism comprises:
a mounting plate for mounting the lever-arm mechanism, wherein the mounting plate is secured on the motor housing;
a lever arm pivoted at one end on the mounting plate, the lever arm being free to move about the pivoted end;
a solenoid secured on the mounting plate, the solenoid being connected to the lever-arm, wherein the solenoid is energized to actuate the lever arm for engaging the pins of the driving wheel with the holes in the clutch plate; and
a counter-balancing spring connected at one end to the mounting plate and at other end to the lever-arm, wherein the counter-balancing spring for retracting the lever arm when solenoid is de-energized.

8. The roll-up door system of claim 6, wherein the solenoid is being energized by an electrical circuit.

9. The roll-up door system of claim 3, wherein the automated driving mechanism further comprises a clutch-disengaging spring placed concentrically along the drive shaft, the clutch-disengaging spring being connected at one end to the driving wheel and at the other end to the clutch plate, wherein the clutch-disengaging spring for disengaging the driving wheel and the clutch plate.

10. The roll-up door system of claim 3, wherein the automated driving mechanism further comprises a spacer ring placed concentrically along the drive shaft, the spacer ring mating with the electric motor at one surface and the lever-arm mechanism at the other surface.

11. The roll-up door system of claim 3, wherein the automated driving mechanism further comprises a bearing plate placed concentrically along the drive shaft, the bearing plate mating with the lever-arm mechanism at one surface and the clutch plate at the other surface.

12. The roll-up door system of claim 1, wherein the linkage mechanism comprises:
an idler wheel;
a power-transmission medium, the power transmission medium comprises an flexible member connecting the driving wheel and the idler wheel; and
a slider-arm linkage moving along the guide-track assembly, wherein the slider-arm linkage is connected at one end to the power transmission medium and at other end to the roll-up door.

13. The roll-up door system of claim 1, wherein each one of the plurality of panels comprises one or more rollers, the rollers being received on the guide-track assembly.

14. The roll-up door system of claim 1, wherein the radio controlled electrical circuit comprises:
a Radio Frequency (RF) receiver, the RF receiver receiving RF signals from a RF transmitter;
a pair of channel relays, the channel relays switching based on the received RF signals;
a polarity reversal module for changing the direction of rotation of the drive shaft of the electric motor, wherein the polarity reversal module receives input from the channel relays and provides output to power lines connected to the electric motor; and
a current-switching module comprising a current sensor connected to power supply of the electric motor, the current sensor measuring the current drawn by the electric motor, wherein the current-switching module switches off the power supply if the current in the electric motor exceeds a set point.

15. The roll-up door system of claim 14, wherein the polarity reversal module comprises a pair of relays receiving input from the channel relays, the relays changing the polarity of power lines connected to the electric motor based on the received input.

16. The roll-up door system of claim 14 further comprising a means for manually operating the roll-up door based on a signal received from the RF transmitter.

17. The roll-up door system of claim 14, wherein the electric motor is stopped if the motion of the roll-up door is obstructed.

18. The roll-up door system of claim 1 further comprising a means for locking the roll-up door, wherein the roll-up door is locked when the roll-up door reaches an end of the guide-track assembly.

19. A roll-up door system comprising:
a guide-track assembly;
a roll-up door comprising a plurality of panels, the panels moving along the guide-track assembly;
a linkage mechanism connected to the roll-up door, wherein the linkage mechanism moving the roll-up door along the guide-track assembly;
an automated driving mechanism connected to the linkage mechanism for controlling the movement of the roll-up door along the guide-track assembly; a radio controlled electrical circuit for activating the automated driving mechanism; and
a Radio Frequency (RF) transmitter for controlling the radio controlled electrical circuit, wherein the RF transmitter comprises:
an up-button, the up-button generating an up-signal for opening the roll-up door; and
a down-button, the down-button generating an down-signal for closing the roll-up door.

20. The roll-up door system of claim 19, wherein the RF transmitter further comprises a stop-button, the stop-button stopping the roll-up door at an intermediate position between ends of the guide-track assembly.

21. A method for operating a roll-up door system, the roll-up door system comprising a radio transmitter, radio controlled electrical circuit, an automated driving mechanism, a roll-up door and a linkage mechanism, wherein the automated driving mechanism comprises an electric motor, a clutch plate, a driving wheel, a lever-arm mechanism and a solenoid, the method comprising:
receiving a signal at the radio controlled electrical circuit, wherein the signal being received from a Radio Frequency (RF) transmitter;
energizing the solenoid, wherein the solenoid is energized by the radio controlled electrical circuit based on the signal;
controlling the electric motor, wherein the electric motor is controlled by the radio controlled electrical circuit on receiving the signal;
actuating the lever-arm mechanism, wherein the lever-arm mechanism is actuated by the energized solenoid;
engaging the clutch plate to the driving wheel, wherein the clutch plate and driving wheel are engaged by the actuated lever-arm mechanism; and
actuating the linkage mechanism to move the roll-up door, wherein the linkage mechanism is actuated by the motor.

22. A method for operating a roll-up door system, the roll-up door system comprising a radio transmitter, radio controlled electrical circuit, an automated driving mechanism, a roll-up door and a linkage mechanism, wherein the automated driving mechanism comprises an electric motor, a clutch plate, a driving wheel, and a solenoid, the method comprising:
receiving a signal at the radio controlled electrical circuit, wherein the signal being received from a Radio Frequency (RF) transmitter;
de-energizing the solenoid, wherein the solenoid is de-energized by the radio controlled electrical circuit based on the signal;
stopping the electric motor, wherein the electric motor is stopped by the radio controlled electrical circuit on receiving the signal;
actuating the lever-arm mechanism, wherein the lever-arm mechanism is actuated by the counter-balancing spring;
disengaging the clutch plate from the driving wheel, wherein the clutch plate and driving wheel are disengaged by the clutch-disengaging spring if the roll-up door is at an intermediate position between ends of the guide-track assembly; and
locking the roll-up door if the roll-up door is at one of the ends of the guide-track assembly, wherein the roll-up door is locked by the engaged clutch plate and driving wheel.
